(19) United States
(12) Patent Application Publication
(10) Pub. No.: US 2002/0079440 A1
(43) Pub. Date: Jun. 27, 2002

(54) Apparatus and method for providing an antigravitational force

(76) Inventor: Randell L. Mills, Newtown, PA (US)

Correspondence Address: LAHIVE & COCKFIELD, 28 STATE STREET, BOSTON, MA, 02109, US

(21) Appl. No.: 09/862,533

(22) Filed: May 21, 2001

Related U.S. Application Data
(63) Continuation of application No. 08/941,325, filed on Sep. 30, 1997, now abandoned.
Application No. 08/941,325 is a continuation of application No. 08/767,519, filed on Dec. 16, 1996, now abandoned.
Application No. 08/767,519 is a continuation of application No. 08/246,860, filed on May 20, 1994, now abandoned.

(51) Int. Cl. H01J 49/00

(52) U.S. Cl. 250/281

(57) ABSTRACT

A method and means to produce an antigravitational force for propulsion and/or levitation comprise a source of fundamental particles including electrons and a means to give the fundamental particles negative curvature; whereas, the gravitating body is comprised of matter of positive curvature where opposite curvatures provide a mutually repulsive antigravitational force. Electrons are given negative curvature by elastically scattering electrons of an electron beam from atoms such that negatively curved electrons (pseudoelectrons) emerge. The emerging beam of negatively curved electrons experience an antigravitational force, and (on the Earth) the beam moves upward (away from the Earth). To use this invention for propulsion or levitation, the antigravitational force of the electron beam is transferred to a negatively charged plate. The Coulombic repulsion between the beam of electrons and the negatively charged plate causes the plate (and anything connected to the plate) to lift. The craft is made to have angular momentum Which is tilted relative to the axis defined by the gravitational force such that acceleration tangential to the surface of a gravitating body is achieved via conservation of the angular momentum.

### BACKGROUND OF THE INVENTION

1. Field of the Invention

This invention relates to methods and apparatus for providing repulsion, in particular methods and apparatus for providing antigravitational repulsive forces adapted to provide propulsion and levitation.

2. Description of the Related Art

The attractive gravitational force has been the subject of investigation for centuries. Traditionally, gravitational attraction has been investigated in the field of astrophysics applying a large scale perspective of cosmological spacetime, as distinguished from currently held theories of atomic and subatomic structure. However, gravity originates on the atomic scale. The atomic theory of gravity is derived in the Gravity Section and the Forces Section [The Unification of Spacetime, the Forces, Matter, and Energy, Mills, R., Technomic Publishing Company, Lancaster, Pa., (1992)]. The basis of atomic gravity is the effect of the curvature of fundamental particle which are spatially two dimensional on the curvature of spacetime according to the Theory of General Relativity.

In Newtonian gravitation, the mutual attraction between two particles of masses m₁ and m₂ separated by a distance r is

$$F = G \frac{{m}_{1} {m}_{2}}{{r}^{2}} \qquad ( 1 )$$

where G is the gravitational constant, its value being 6.67×10⁻¹¹Nm² kg⁻². Although Newton's theory gives a correct quantitative description of the gravitational force, the most elementary feature of gravitation is still not well defined. Which feature of gravitation is then the most important, if we were to consider the most fundamental? By comparing Newton's second law,

F=ma (2)

with his law of gravitation, we can describe the motion of a freely falling object by using the following equation:

$${m}_{i} \vec{a} = {m}_{g} \frac{{GM}_{⊕}}{{r}^{3}} \vec{r} \qquad ( 3 )$$

where mᵢ and m_{g} represent respectively the object's inertial mass (inversely proportional to acceleration) and the gravitational mass (directly proportional to gravitational force), M_{⊕} is the gravitational mass of the Earth, and r is the position vector of the object taken from the center of the Earth. The above equation can be rewritten as

$$a = \frac{{m}_{g}}{{m}_{i}} ( \frac{{GM}_{⊕}}{{r}^{2}} ) \qquad ( 4 )$$

Extensive experimentation dating from Galileo's Pisa experiment to the present has shown that irrespective of the object chosen, the acceleration of an object produced by the gravitational force is the same, which from Eq. (4) implies that the value of m_{g}/mᵢ should be the same for all objects. In other words, we have

m_{g}/mᵢ=universal constant. (5)

The equivalence of the gravitational mass and the inertial mass-the fractional deviation of Eq. (5) from a constant is experimentally confirmed to less 1×10⁻¹¹ [Adelberger, E. G., Stubbs, C. W., Heckel, B. R., Su, Y., Swanson, H. E., Smith, G., Gundlach, J. H., Physical Review D, Vol. 42, No. 10, (1990), pp. 3267-3292]. In physics, the discovery of a universal constant often leads to the development of an entirely new theory. From the universal constancy of the velocity of light c, the special theory of relativity was derived; and from Planck's constant h, the quantum theory was deduced. Therefore, the universal constant m_{g}/mᵢ should be the key to the gravitational problem. The theoretical difficulty with Newtonian gravitation is to explain just why relation, Eq. (5), exists implicitly in Newton's theory as a separate law of nature besides Eqs. (1) and (2). Furthermore, discrepancies between certain astronomical observations and predictions based on Newtonian celestial mechanics exist, and they could not be reconciled until the development of Einstein's Theory of General Relativity which can be transformed to Newtonian gravitation on the scale in which Newton's theory holds.

As a result of the erroneous assumptions and incomplete or erroneous models and theories, the development of useful or functional systems and structures requiring an accurate understanding of atomic structure and the nature of gravity on the atomic scale have been inhibited. On a cosmological scale, the Theory of General Relativity is correct experimentally; however, it is incompatible with the current atomic theory of quantum mechanics. And, the Schrodinger equation upon which quantum mechanics is based does not explain the phenomenon of gravity and, in fact, predicts infinite gravitational fields in empty vacuum. Thus, advances in development of propulsion systems which function according to gravitational forces on the atomic scale are prohibited.

### SUMMARY OF THE INVENTION

Overview of the Novel Theoretical Basis

While the inventive methods and apparatus described in detail further below may be practiced as described, the following discussion of a novel theoretical basis of the invention is provided for additional understanding.

A novel atomic theory is disclosed in my previous U. S. Patent application entitled “Apparatus and Method for Providing an Antigravitational Force” , Ser. No. 368,246 filed on Jun. 14, 1989 which is incorporated herein by this reference. The novel atomic theory is further disclosed in The Unification of Spacetime, the Forces, Matter, and Energy, Mills, R., Technomic Publishing Company, Lancaster, Pa., (1992); The Grand Unified Theory, Mills, R. and Farrell, J., Science Press, Ephrata, Pa., (1990); Mills, R., Kneizys, S., Fusion Technology., Vol. 210, (1991), pp. 65-81; R. Mills, W. Good, and R. Shaubach, Fusion Technology, Vol. 25, 103 (1994), and in my previous U.S. patent applications entitled “Energy/Matter Conversion Methods and Structures”, Ser. No. 08/107,357 filed on Aug. 16, 1993, which is a continuation-in-part application of “Energy/Matter Conversion Methods and Structures”, Ser. No. 08/075,102 filed on Jun. 11, 1993, which is a continuation-in-part application of Ser. No. 07/626,496 filed on Dec. 12,1990 which is a continuation-in-part application of Ser. No. 07/345,628 filed Apr. 28, 1989 which is a continuation-in-part application of Ser. No. 07/341,733 filed Apr. 21, 1989 which are incorporated herein by this reference.

On a cosmological scale, the Theory of General Relativity is correct experimentally; however, it is based on a flawed dynamic formulation of Galileo's law. Einstein took as the basis to derive his gravitational field equations a certain kinematical consequence of that law which he called the “Principle of Equivalence” which does not provide a quantum gravitational theory. Furthermore, General Relativity is a partial theory in that it deals with matter on cosmological scale, but not an atomic scale. All gravitating bodies are composed of matter and are collections of atoms which are composed of fundamental particles such as electrons, which are leptons, and quarks which make up protons and neutrons. Gravity originates from the fundamental particles.

The effects of gravity preclude the existence of inertial frames in a large region, and only local inertial frames, between which relationships are determined by gravity are possible. In short, the effects of gravity are only in the determination of the local inertial frames. The frames depend on gravity and the frames describe the spacetime background of the motion of matter; therefore, differing from other kinds of forces, gravity which influences the motion of matter by determining the properties of spacetime is itself described by the metric of spacetime. It is demonstrated that gravity arises from the two spatial dimensional mass density functions of the fundamental particles that makes up all matter of the universe.

It is demonstrated in the One Electron Atom Section [The Unification of Spacetime, the Forces. Matter. and Energy, Mills, R., Technomic Publishing Company, Lancaster, Pa., (1992)] that a bound electron is a two-dimensional spherical shell—an orbitsphere. Euclidean plane geometry asserts that (in a plane) the sum of the angles of a triangle equals 180°. In fact, this is the definition of a flat surface. For a triangle on an orbitsphere the sum of the angles is greater than 180°, and the orbitsphere has positive curvature. For some surfaces the sum of the angles of a triangle is less than 180°; these are said to have negative curvature.

| sum of angles | |
|---|---|
| of a triangle | type of surface |
| >180° | positive curvature |
| =180° | flat |
| <180° | negative curvature |

The measure of Gaussian curvature, k, at a point on a two dimensional surface is

$$k = \frac{1}{{r}_{1} {r}_{2}} \qquad ( 6 )$$

the inverse product of the radius of the maximum and minimum circles, r₁, and r₂, which fit the surface at the point, and the radii are normal to the surface at the point. By a theorem of Euler, these two circles lie in orthogonal planes. For a sphere, the radii of the two circles of curvature are the same at every point and equivalent to the radius of a great circle of the sphere. Thus, the sphere is a surface of constant curvature;

$$k = \frac{1}{{r}^{2}} \qquad ( 7 )$$

at every point. In case of positive curvature of which the sphere is an example, the circles fall on the same side of the surface, but when the circles are on opposite sides, the curve has negative curvature. A saddle, a cantenoid, and a pseudosphere are negatively curved. The general equation of a saddle is

$$z = \frac{{x}^{2}}{{a}^{2}} - \frac{{y}^{2}}{{b}^{2}} \qquad ( 8 )$$

The curvature of the surface of Eq. (8) is

$$k = {\frac{- 1}{4 {a}^{2} {b}^{2}} [ \frac{{x}^{2}}{{a}^{4}} + \frac{{y}^{2}}{{b}^{4}} + \frac{1}{4} ]}^{- 2} \qquad ( 9 )$$

A pseudosphere is constructed by revolving the tractrix about it asymptote. For the tractrix, the length of any tangent measured from the point of tangency to the x-axis is equal to the height R of the curve from its asymptote-in this case the x-axis. The pseudosphere is a surface of constant negative curvature. The curvature, k

$$k = \frac{- 1}{{r}_{1} {r}_{2}} = \frac{- 1}{{R}^{2}} \qquad ( 10 )$$

given by the product of the two principal curvatures on opposite sides of the surface is equal to the inverse of R squared at every point where R is the equitangent. R is also known as the radius of the pseudosphere.

General Relativity, Special Relativity, and Maxwell's Equations are valid on any scale. The origin of the fundamental particles is determined by the combination of these laws. And, the fields of fundamental particles are according to these laws. It is shown in the Lepton Section, the Neutron and Proton Production Section, and the Quark Section [The Unification of Spacetime, the Forces, Matter, and Energy, Mills, R., Technomic Publishing Company, Lancaster, Pa., (1992)] that the masses and charges of the fundamental particles are determined by the equations of the transition state orbitsphere where the nonradiative boundary condition must hold given that the vectors of this condition are contravariant due to General Relativistic effects. Mass causes spacetime to become curved; consequently, proper time and coordinate are not the same. The masses of fundamental particle are derived from the relationship between these two times in the Lepton Section and the Neutron and Proton Production Section [The Unification of Spacetime, the Forces, Matter, and Energy, Mills, R., Technomic Publishing Company, Lancaster, Pa., (1992)].

All matter is comprised of fundamental particles, and all fundamental particles exists as mass confined to two spatial dimensions. The surface is positively curved in the case of a particle as an orbitsphere, or the surface is negatively curved in the case of an electron as a pseudosphere (hereafter called a pseudoelectron). The effect of this “local” curvature on the non-local spacetime is to cause it to be Riemannian or hyperbolic as opposed to Euclidean which is manifest as a gravitational field or an antigravitational field, respectively. Thus, the spacetime is curved with constant spherical curvature in the case of an orbitsphere, or spacetime is curved with constant hyperbolic curvature in the case of a pseudoelectron. Thus, given that fundamental particles are two dimensional in nature and that the gravitational and inertial masses are equivalent, General Relativity is a quantum theory of gravitation which is valid on any scale. With these provisions the unified theory of gravitation is derived by first establishing a metric.

A space in which the curvature tensor has the following form:

R_{μν,αβ}=K·(g_{84 α}g_{82 β}−g_{μα}g_{νβ}) (11)

is called a space of constant curvature, it is a four-dimensional generalization of Lobachevsky space. The constant K is called the constant of curvature. The curvature of spacetime will be shown to result from a discontinuity of matter confined to two spatial dimensions. This is the property of all matter including matter as an orbitsphere. Consider an isolated orbitsphere of radius rₙ, and radial distances, r, from its center. For r less than rₙ, there is no mass; thus, spacetime is flat or Euclidean. The curvature tensor applies to all space of the inertial frame considered; thus, for r less than rₙ, K=O. At r=rₙ there exists a discontinuity of mass of the orbitsphere. This results in a discontinuity of the curvature tensor for radial distances greater than or equal to rₙ. The discontinuity gives rise to a boundary value problem of Einstein's gravitational field equations which equate the properties of matter with the curvature of spacetime. The derivation of the gravitational radius of the orbitsphere and infinitesimal spatial and temporal displacements in spacetime which is curved by the presence of the orbitsphere follows from the corresponding derivations for the transition state orbitsphere given in the Gravity Section [The Unification of Spacetime, the Forces, Matter, and Energy, Mills, R., Technomic Publishing Company, Lancaster, Pa., (1992)].

In the theory of General Relativity, Einstein's field equations give the relationship whereby matter determines the curvature of spacetime which is the origin of gravity. The definitive form of the equations are as follows:

$${R}_{μ v} - \frac{1}{2} g α β R = \frac{- 8 π G}{{c}^{4}} T μ v \qquad ( 12 )$$

where R_{μν}=g_{αβ}R_{μν}, R=g_{αβ}R_{μν}, the left-half of Eq. (12) is Einstein's Tensor, and T_{μν}is the stress-energy-momentum tensor. Einstein derived Eq. (12) starting with the assumption of the local equivalence of accelerated and gravitational inertial reference frames. However, this assumption leads to conflicts with Special Relativity.

The correct basis to derive Eq. (12) is the principle of the equivalence of the inertial and gravitational mass [Fock, V., The Theory of Space, Time, and Gravitation, The MacMillan Company, (1964)] provided by the orbitsphere model and the principle that all particles including light follow geodesics.

The Schwarzschild metric is the solution of the boundary value problem of Einstein's gravitational field equations applied to an orbitsphere, where a discontinuity in mass is equated with a discontinuity of the curvature of spacetime.

The gravitational radius, αhd g or r_{g}, of an orbitsphere of mass m is

$${α}_{g} = {r}_{g} = \frac{G m}{{c}^{2}} \qquad ( 13 )$$

where G is the Newtonian gravitational constant. The gravitational radius of an orbitsphere can be derived by substituting

$$μ = \frac{m}{4 π {r}_{n}} δ ( r - {r}_{n} )$$

for μ in Eq. (57.38) of Fock [Fock, V., The Theory of Space, Time, and Gravitation, The MacMillan Company, (1964)] where m is the mass of the orbitsphere. The solution of Einstein's gravitational equations for the infinitesimal spatial [Fock, V., The Theory of Space, Time, and Gravitation, The MacMillan Company, (1964)], ds², and temporal displacement [Fong, L. Z., and Ruffrni, R., Basic Concepts in Relativistic Astrophysics, World Scientific, (1983)], dτ^{2,} corresponding to the orbitsphere are:

$${ds}^{2} = {c}^{2} [ \frac{r - \frac{{Gm}_{o}}{{c}^{2}}}{r + \frac{{Gm}_{o}}{{c}^{2}}} ] {dt}^{2} - [ \frac{r + \frac{{Gm}_{o}}{{c}^{2}}}{r - \frac{{Gm}_{o}}{{c}^{2}}} ] {dr}^{2} - {( r + \frac{{Gm}_{o}}{{c}^{2}} )}^{2} ( d {θ}^{2} + {sin}^{2} θ {d}_{φ}^{2} ) \qquad ( 14 )$$

$$d {τ}^{2} = ( 1 - \frac{2 {Gm}_{o}}{{c}^{2} r} ) {dt}^{2} - \frac{1}{{c}^{2}} [ ( \frac{{dr}^{2}}{1 - \frac{2 {Gm}_{o}}{{c}^{2} r}} ) + {r}^{2} d {θ}^{2} + {r}^{2} {sin}^{2} θ {d}_{φ}^{2} ] \qquad ( 15 )$$

where r is the orbitsphere radius and mₒ is the orbitsphere mass. For

$$\frac{{r}_{g}}{r} << 1 ,$$

<<1, the gravitational force on an object of mass m due to an orbitsphere of mass mₒ is

$$F = \frac{{Gm}_{o} m}{{r}^{2}} \qquad ( 16 )$$

where G is the Newtonian gravitational constant.

The solution of the gravitational field equations given in Fock [Fock, V., The Theory of Space, Time, and Gravitation, The MacMillan Company, (1964)] permits a result corresponding to a gravitational radius of the opposite sign. The field equation solutions, Eqs. (14) and (15), for a positive value for α of Eq. (13) and Eq. (57.37) of Fock [Fock, V., The Theory of Space, Time, and Gravitation, The MacMillan Company, (1964)] correspond to positive curvature. And, field equation solutions exist for a negative value for α of Eq. (13) and Eq. (57.37) of Fock [Fock, V., The Theory of Space, Time, and Gravitation, The MacMillan Company, (1964)] which correspond to negative curvature. Thus, antigravity can be created by forcing matter into negative curvature. A fundamental particle with negative curvature would experience a central but repulsive force with a gravitating body comprised of matter of positive curvature.

Antigravity Device.

In Einstein's Theory of General Relativity, the origin of gravity is the curvature of spacetime by matter. On the atomic scale, the curvature, K, of ordinary matter is given by

$$\frac{1}{{r}_{n}^{2}} ,$$

where rₙ is the radius of the radial delta function (for an electron, the radius of the orbitsphere). It is this local, positive curvature of the electron that causes gravity. [It is worth noting that all ordinary matter, comprised of leptons and quarks, has positive curvature.]

In the Detailed Description of the Invention Section, a free electron is shown to be a two-dimensional plane wave—a flat surface. Because the gravitational mass depends on the positive curvature of a particle, a free electron has inertial mass but not gravitational mass. Thus, a free electron is not gravitationally attracted to ordinary matter. Furthermore, it is possible to give the electron negative curvature and, therefore, cause antigravity.

Antigravity Methods and Means

The present invention of a propulsion and levitation device comprises a source of matter, a means to form the matter into negative curvature, and a means to produce a force on the negatively curved matter where the force balances the repulsive gravitational force between the negatively curved matter and a gravitating body. In response to the force balance, the matter of negative curvature moves at constant velocity to produce useful work against the gravitational field of the gravitating body. The constant velocity including zero velocity, provides that the current density function of negative curvature which is a solution to the three-dimensional wave equation does not possess spacetime Fourier components synchronous with waves traveling at the speed of light. Therefore, it does not radiative.

In one embodiment the antigravity propulsion and levitation means comprises a means to inject particles, such as electrons, as plane waves, which serve as the matter, and further includes a guide of the plane waves. Negative curvature of the injected and guided matter is effected by applying a force on the matter. The applied force is provided by one or more of an electric field, a magnetic field, or an electromagnetic field. A second force on the negatively curved matter is applied in the direction of the gravitational force. This second force is provided by one or more of an electric field, a magnetic field or an electromagnetic field. In a preferred embodiment, the force in the gravitational direction is equal to the repulsive, antigravity force which develops between the gravitating body and the matter due to the negative curvature of the guided matter. The repulsive force of the gravitating body is then transferred to the guide (source of the second force) which further transfers the force to the attached structure to be accelerated or levitated.

In a preferred embodiment of a propulsive device, a vehicle to be accelerated comprises an antigravity levitating device and a flywheel which rotates about its axis. The antigravity force provides pure radial acceleration when the vehicle's gravitational forces are equally exceeded. An imbalance of central force applied to the vehicle will cause it to tilt. By virtue of the angular momentum of the spinning flywheel a tangential acceleration is produced which conserves angular momentum. Then high acceleration and velocity are provided by accelerating the structure along a hyperbolic path around a gravitating body such that the structure is accelerated to high velocity.

Preferred Embodiment of the Antigravity Device.

It is possible to give electrons negative curvature by elastically scattering electrons of an electron beam from atoms such that negatively curved electrons (pseudoelectrons) emerge. The emerging beam of negatively curved electrons experience an antigravitational force, and (on the Earth) the beam will tend to move upward (away from the Earth). To use this invention for propulsion or levitation, the antigravitational force of the electron beam is transferred to a negatively charged plate. The Coulombic repulsion between the beam of electrons and the negatively charged plate causes the plate (and anything connected to the plate) to lift.

### BRIEF DESCRIPTION OF THE FIGURES

These and further features of the present invention will be better understood by reading the following Detailed Description of the Invention taken together with the Drawing, wherein:

FIG. 1 is a two-dimensional graph showing the cross-section of the magnetic potential and the corresponding magnetic field lines (arrows) at a point along the channel of guiding and field generating means of FIG. 7;

FIG. 2 is a three-dimensional graph which shows the magnitude of the electric force in the z direction due to the electric potential function, xyz and the magnitude of the magnetic force in the z direction due to the magnetic potential function, xy where the electron beam propagates in the z direction;

FIG. 3 is the saddle-shaped two-dimensional electron mass density function that propagates along the channel of the electron guide means of FIG. 7;

FIG. 4 is the front view of the magnitude of the mass density function in the plane of a free electron;

FIG. 5 is the side view of a free electron along the axis of propagation;

FIG. 6 is a pseudoelectron having a pseudospherical-shaped mass density function;

FIG. 7 is a drawing of a system of the antigravity propulsion and levitation means according to one embodiment of the present invention;

FIG. 8 is a schematic of the forces of gravitation, antigravitation, and angular momentum acting on a vehicle according to one embodiment of the present invention;

FIG. 9 is a drawing of an experimental apparatus according to one embodiment of the present invention to produce electrons of negative curvature with concomitant production of antigravity forces;

FIG. 10 is a drawing which shows the distribution of negative curvature and antigravitational forces in a relativistic electron beam following a pass through a quadrapole magnetic triplet of the apparatus of FIG. 9; and

FIG. 11 is a block diagram of an antigravitational propulsion device powered by a HECTER system according to one embodiment of the present invention.

FIG. 12 is a drawing of the preferred embodiment of an antigravity device which produces pseudoelelectrons via the elastic scattering of electrons from neutral atoms where the radius of the electron and the radius of the atom are equal.

### DETAILED DESCRIPTION OF THE INVENTION

Electron in Free Space.

The radius of an orbitsphere increases with the absorption of electromagnetic energy [Clark, D., “Very large hydrogen atoms in interstellar space”, Journal of Chemical Education, 68, No. 6, (1991), pp. 454-455]. Upon ionization, the radius of the spherical shell, orbitsphere, goes to infinity as is the case with a spherical wavefront of light emitted from a symmetrical source. The ionized electron is a plane wave that propagates as a wavefront with the de Broglie wave length, λ=h/p where the size of the electron is the de Broglie wavelength. Analogously, as the radius of a spherical wavefront of light goes to infinity its propagation is given by the plane wave equation:

E=Eₒe^{-jk}z^{z} (17)

Light and electrons display identical propagation and diffraction behavior. (This is expected because an electron is created from a photon as derived in the Pair Production Section [The Unification of Spacetime, the Forces, Matter, and Energy, Mills, R., Technomic Publishing Company, Lancaster, Pa., (1992)]). Electrons behave as two dimensional wavefronts with the de Broglie wave length, λ=h/p, in double-slit experiments (Davisson-Germer experiment) [Matteucci, G., “Electron wavelike behavior: a historical and experimental introduction”, Am. J. Phys., 58, No. 12, (1990), pp. 1143-1147]. The plane wave nature of free electrons is demonstrated in the Derivation of Electron Scattering by Helium Section [The Unification of Spacetime, the Forces, Matter, and Energy, Mills, R., Technomic Publishing Company, Lancaster, Pa., (1992)]. (The proton and neutron also demonstrate interference patterns during diffraction because they are locally two dimensional having the de Broglie wavelength.)

As r goes to infinity the electron becomes ionized and is a plane wave with the de Broglie wavelength. The ionized electron traveling at constant velocity is nonradiative and is two dimensional surface having a total charge of e and a total mass of mₑ. The solution of the spacetime charge density function of the ionized electron is solved as a boundary value problem as described previously for the bound electron in the One Electron Atom Section [The Unification of Spacetime, the Forces, Matter, and Energy, Mills, R., Technomic Publishing Company, Lancaster, Pa., (1992)]. The ionized electron is the projection of the orbitsphere into a plane that linearly propagates along on axis perpendicular to the plane. A solution of the spacetime charge density function is sought which is a solution of the Classical Wave Equation (Eq. (1.1) of Mills [The Unification of Spacetime, the Forces, Matter, and Energy, Mills, R., Technomic Publishing Company, Lancaster, Pa., (1992)]) and which possesses no spacetime Fourier components synchronous with waves traveling at the speed of light.

The ionized electron is the projection of the orbitsphere into the x-y plane of Cartesian coordinates that propagates linearly along the z axis. The mass density function, a(r,θ,z), of the electron with linear velocity along the z axis of v_{z} given by Eq. (1.47) of Mills [The Unification of Spacetime, the Forces, Matter, and Energy, Mills, R., Technomic Publishing Company, Lancaster, Pa., (1992)]

$${v}_{z} = \frac{ℏ}{{m}_{e} {r}_{o}} . \qquad ( 18 )$$

and which possesses time harmonic charge motion in the x-y plane is given by the projection into the x-y plane of the convolution, *, of a plane with an orbitsphere. The convolution is

π(z)*σ(r−rₒ)=\sqrt{r ₒ²−z²}σ(r−\sqrt{rₒ²−z²}) (19)

The projection of Eq.(19) into the x-y plane is

$$a ( r , θ , z ) = π ( \frac{r}{2 {r}_{o}} ) \sqrt{{r}_{o}^{2} - {r}^{2}} δ ( z ) \qquad ( 20 )$$

where a(r,θ,z) is given in cylindrical coordinates, the plane wave, represented by π(z), is given in Cartesian coordinates with the propagation direction along the z axis, the orbitsphere function is given in spherical coordinates, and the function,

$$π ( \frac{r}{2 {r}_{o}} )$$

represents a two dimensional disk of radius rₒ. The total mass is mₑ. Thus, Eq. (20) must be normalized.

$${m}_{e} = A {\int }_{0}^{2 π} {\int }_{- ∞}^{∞} \sqrt{{r}_{o}^{2} - {r}^{2}} r ⅆ r ⅆ θ \qquad ( 21 )$$

$$A = \frac{{m}_{e}}{\frac{2}{3} π {r}_{o}^{3}} \qquad ( 22 )$$

The mass density function of a free electron is a two dimensional disk having the mass density distribution in the x-y (r) plane

$$a ( r , θ , z ) = \frac{{m}_{e}}{\frac{2}{3} π {r}_{o}^{3}} π ( \frac{r}{2 {r}_{o}} ) \sqrt{{r}_{o}^{2} - {r}^{2}} δ ( z ) \qquad ( 23 )$$

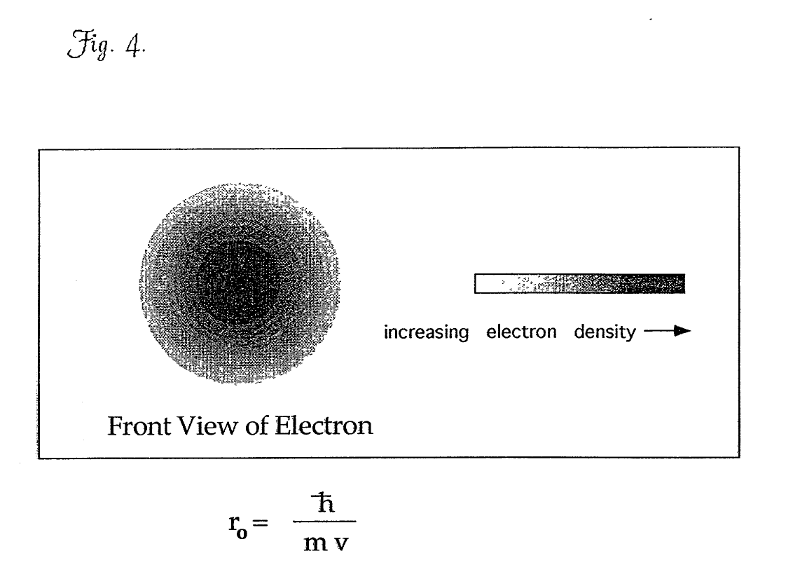

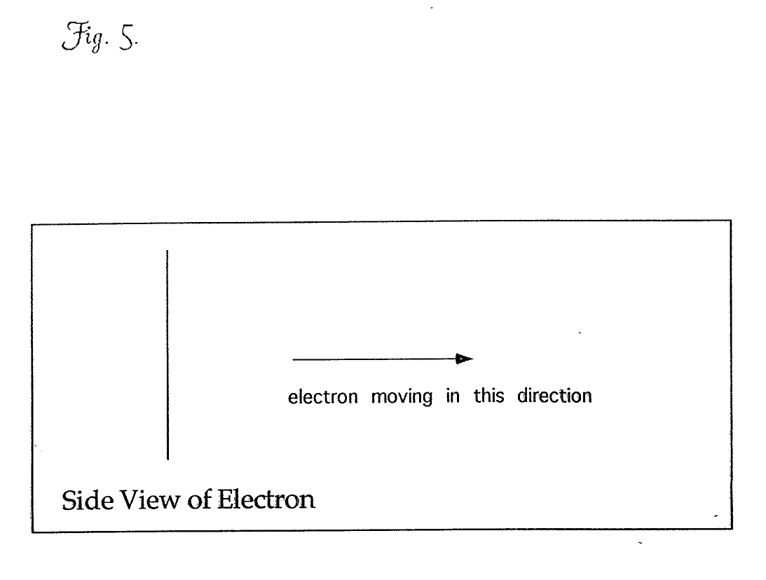

and charge density distribution, c(r,θ,z), in the x-y plane

$$c ( r , θ , z ) = \frac{e}{\frac{2}{3} π {r}_{o}^{3}} π ( \frac{r}{2 {r}_{o}} ) \sqrt{{r}_{o}^{2} - {r}^{2}} δ ( z ) \qquad ( 24 )$$

where c(r,θ,z) is given in cylindrical coordinates. The front view of the magnitude of the mass density function in the plane of a free electron is shown in FIG. 4; the side view of a free electron along the axis of propagation is shown in FIG. 5.

This surface has an electric field equivalent to a point charge at the origin along the z axis as shown in the Electric Field of the Free Electron Section. The current density function is the product of the charge density function times the angular velocity density function. The charge density function of the free electron is given by Eq. (24). The angular velocity of the orbitsphere is given by Eq. (1.55) of Mills [The Unification of Spacetime, the Forces, Matter, and Energy, Mills, R., Technomic Publishing Company, Lancaster, Pa., (1992)] is

$$ω = \frac{ℏ}{{m}_{e} {r}^{2}} . \qquad ( 25 )$$

During ionization of the electron, the total angular momentum must be conserved. The current density function of a free electron propagating with velocity v_{z} along the z axis is given by the vector projections of the current into x-y plane for r=rₒ to r=∞ which corresponds to the ionization of the electron initially bound as an orbitsphere of radius r=rₒ. The current density function, i(r,θ,z,t), is the projection into the x-y plane of the integral of the product of the projections of the charge of the orbitsphere (Eq. (24)) times the angular momenta as a function of the radius r of the ionizing orbitsphere (Eq. (25)) for r=rₒ to r=∞. The integral is

$$\int ωπ ( z ) * δ ( r - {r}_{o} ) ⅆ r = \frac{e}{\frac{2}{3} π {r}_{o}^{3} {r}_{o}} {\int }^{∞} \frac{ℏ}{{m}_{e} {r}^{2}} \sqrt{{r}_{o}^{2} - {z}^{2}} δ ( r - \sqrt{{r}_{o}^{2} - {z}^{2}} ⅆ r \qquad ( 26 )$$

The projection of Eq.(26) into the x-y plane is

$$i ( r , θ , z , t ) = π ( \frac{r}{2 {r}_{o}} ) \frac{e}{\frac{4}{3} π {r}_{o}^{3}} \frac{ℏ}{{m}_{e} \sqrt{{r}_{o}^{2} - {r}^{2}}} exp ( - ⅈω t ) δ ( z - {v}_{z} t ) \qquad ( 27 )$$

The factor of

$$\frac{1}{2}$$

in Eq. (27) arises from the vector projection of the angular momentum of the orbitsphere into the x-y plane as follows from Eqs. (1.68 - 1.71) and FIGS. 1.3 and 1.4 of Mills [The Unification of Spacetime, the Forces, Matter, and Energy, Mills, R., Technomic Publishing Company, Lancaster, Pa., (1992)]. The angular momentum, L, is given by

L=mₑr²ω) (28)

Substitution of mₑ for e in Eq. (27) followed by substitution into Eq. (28) gives the angular momentum density function, L

$$L = π ( \frac{r}{2 {r}_{o}} ) \frac{{m}_{e}}{\frac{4}{3} π {r}_{o}^{3}} \frac{ℏ}{{m}_{e} \sqrt{{r}_{o}^{2} - {r}^{2}}} {r}^{2} \qquad ( 29 )$$

The total angular momentum of the free electron is given by integration over the two dimensional disk having the angular momentum density given by Eq. (29).

$$L = {\int }_{0}^{2 π} {\int }_{0}^{{r}_{o}} π ( \frac{r}{2 {r}_{o}} ) \frac{{m}_{e}}{\frac{4}{3} π {r}_{o}^{3}} \frac{ℏ}{{m}_{e} \sqrt{{r}_{o}^{2} - {r}^{2}}} {r}^{2} r ⅆ r ⅆ θ \qquad ( 30 )$$

Eq. (30) is in agreement with Eq. (1.125) of Mills [The Unification of Spacetime, the Forces, Matter, and Energy, Mills, R., Technomic Publishing Company, Lancaster, Pa., (1992)]; thus, angular momentum is conserved. The four dimensional spacetime charge density function of the free electron that propagates along the z axis with velocity given by Eq. (18) corresponding to r=rₒis given by substitution of Eq. (18) into Eq. (27)

$$i ( r , θ , z , t ) = π ( \frac{r}{2 {r}_{o}} ) \frac{e}{\frac{4}{3} π {r}_{o}^{3}} \frac{ℏ}{{m}_{e} \sqrt{{r}_{o}^{2} - {r}^{2}}} exp ( - ⅈω t ) δ ( z - \frac{ℏ}{{m}_{e} {r}_{o}} t ) \qquad ( 32 )$$

The spacetime Fourier Transform of Eq. (32) is [Bracewell, R. N., The Fourier Transform and Its Applications, McGraw-Hill Book Company, New York, (1978), pp. 248-249]

$$\frac{e}{\frac{4}{3} π {r}_{o}^{3}} \frac{ℏ}{{m}_{e}} sin c ( 2 π {sr}_{o} ) \frac{1}{4 π} [ δ ( ω - {ω}_{o} ) + δ ( ω + {ω}_{o} ) ] {ⅇ}^{- j {k}_{z} {r}_{o}} \qquad ( 33 )$$

The condition for nonradiation of a charge density function is that the spacetime Fourier transform of the charge density function must not possess waves synchronous with waves traveling at the speed of light, that is synchronous with

$$\frac{{ω}_{n}}{c}$$

or synchronous with

$$\frac{{ω}_{n}}{c} \sqrt{\frac{ϵ}{{ϵ}_{O}}}$$

where ε is the dielectric constant of the medium. The Fourier transform of the free electron is given by Eq. (33). Consider the radial and time parts of the Fourier transform:

$$sin {c2sr}_{o} \frac{1}{4 π} [ δ ( ω - {ω}_{o} ) + δ ( ω + {ω}_{o} ) ] = \frac{sin 2 π {sr}_{o}}{2 π {sr}_{o}} \frac{1}{4 π} [ δ ( ω - {ω}_{o} ) + δ ( ω + {ω}_{o} ) ] ; \qquad ( 34 )$$

For time harmonic motion corresponding to the electron parameters ωₒ and sₒ,

2πrₒ=ηₒ (35)

Thus,

$${r}_{o} = \frac{{λ}_{o}}{2 π} \qquad ( 36 )$$

For the current circle in the x-y plane of radius rₒ with the mass of the current circle distributed over a total of 2π radians,

$${s}_{o} = \frac{2 π}{{λ}_{o}} \qquad ( 37 )$$

Thus, the argument of the sin function of the sine function is

$$2 π \frac{2 π}{{λ}_{o}} \frac{{λ}_{o}}{2 π} = 2 π \qquad ( 38 )$$

Substitution of 2π into the sine function results in the vanishing of the entire Fourier Transform of the charge density function. Thus, spacetime harmonics of

$$\frac{{ω}_{n}}{c} = k$$

or

$$\frac{{ω}_{n}}{c} \sqrt{\frac{ϵ}{{ϵ}_{O}}} = k$$

do not exist. Radiation due to charge motion does not occur in any medium when this boundary condition is met.

It follows from Eq. (18) and Eq. (35) that the wavelength of the free electron is

$${λ}_{o} = \frac{h}{{m}_{e} {v}_{z}} = 2 π {r}_{o} \qquad ( 39 )$$

which is the de Broglie wavelength.

The free electron is a two dimensional disk with a charge distribution given by Eq. (24) having a radius rₒ given by Eq. (39). This distribution is a minimal energy surface. An attractive magnetic force exists between current circles in the x-y plane. The force balance equation is given by equating the centrifugal and centripetal magnetic electrodynamic force as given in the Two Electron Atom Section [The Unification of Spacetime, the Forces, Matter, and Energy, Mills, R., Technomic Publishing Company, Lancaster, Pa., (1992)]. The magnetic field, B, of each current loop of current, i, is

$$B = \frac{{μ}_{o} i}{2 π r} \qquad ( 40 )$$

The force balance between the Lorentzian Force and the centrifugal force is

$$mv ω = \frac{1}{2} evB \qquad ( 41 )$$

Substitution of Eq. (40) and

$$i = e \frac{ω}{2 π} \qquad ( 42 )$$

into Eq. (41) gives

$$ω = [ \frac{{e}^{2} {μ}_{o}}{2 {m}_{e} r} ] \frac{ω}{{( 2 π )}^{2}} \qquad ( 43 )$$

According to invariance of charge under Gauss's Integral law, the relativistic correction for current, i, and the charge, e, is 2π, and it follows from that Eq. (3.6) and Eq. (3.15) of Mills [The Unification of Spacetime, the Forces, Matter, and Energy, Mills, R., Technomic Publishing Company, Lancaster, Pa., (1992)] that the term in brackets is factored out as the relativistic correction for the electrodynamic force between current loops. Thus, from Eq. (43),

ω=ω (44)

And, the electron is in force balance.

Furthermore, the free electron possesses a total charge e, a total mass mₑ, and a total angular momentum of h. The magnetic moment is given by Eq. (15.27) of Mills [The Unification of Spacetime, the Forces, Matter, and Energy, Mills, R., Technomic Publishing Company, Lancaster, Pa., (1992)]; thus,

$${μ}_{B} = \frac{e ℏ}{2 {m}_{e}} = 9.274 \times {10}^{- 24} {JT}^{- 1} \qquad ( 45 )$$

which is the Bohr magneton. Conservation of angular momentum with the linking of the magnetic flux quantum gives rise to the spin quantum number, mₛ, and the fluxon g factor which is the same as given previously in the Electron g Factor Section [The Unification of Spacetime, the Forces, Matter, and Energy, Mills, R., Technomic Publishing Company, Lancaster, Pa., (1992)].

The free electron possesses current in the x-y plane given by Eq. (32), the current along the z axis follows from Eq. (1.54) of Mills [The Unification of Spacetime, the Forces, Matter, and Energy, Mills, R., Technomic Publishing Company, Lancaster, Pa., (1992)] and Eqs. (18), and (42)

$$i = e \frac{ω}{2 π} = \frac{e ℏ}{2 π {m}_{e} {r}_{o}^{2}} . \qquad ( 46 )$$

The energy of interaction of the magnetic moment of a Bohr magneton of the free electron with the applied magnetic field is minimized. The total angular momentum vector of magnitude h precesses about the z axis, the axis of the magnetic field, at an angle of

$$\frac{π}{4}$$

which results in a projection of

$$\sqrt{\frac{3}{4}}$$

h onto the z axis, and the equivalent distribution of angular momentum as that given is FIG. 1.4 of Mills [The Unification of Spacetime, the Forces, Matter, and Energy, Mills, R., Technomic Publishing Company, Lancaster, Pa., (1992)]. The precessing free electron comprising a two dimensional disk sweeps out a sphere in space relative to the free electron's inertial frame. And, magnetic flux is linked by the electron in units of the magnetic flux quantum with conservation of angular momentum as in the case of the orbitsphere as the projection of the angular momentum along the magnetic field axis of

$$\sqrt{\frac{3}{4}}$$

h reverses direction. The energy, Eₜₒₜₐₗ, of the spin flip transition corresponding to the

$${m}_{s} = \frac{1}{2}$$

quantum number is given by Eq. (1.146) of Mills [The Unification of Spacetime, the Forces, Matter, and Energy, Mills, R., Technomic Publishing Company, Lancaster, Pa., (1992)].

E ₜₒₜₐₗ=gμ_{β}β (47)

Electric Field of a Free Electron.

The electric potential of a free electron is given by Poisson's Equation for a charge density function, p(\overline{r}′)

$$Φ ( r ) = \int \frac{ρ ( {\overline{r}}^{′} ) ⅆ {v}^{′}}{4 π {ϵ}_{o} \vert \overline{r} - {\overline{r}}^{′} \vert} \qquad ( 48 )$$

and the charge density function of the electron, Eq. (24)

$$Φ ( {x}_{o} , {y}_{o} , {z}_{o} ) = \frac{e}{\frac{2}{3} π {r}_{o} 3} \frac{1}{4 {πϵ}_{o}} {\int }_{- {r}_{o}}^{{r}_{o}} {\int }_{- {r}_{o}}^{{r}_{o}} \frac{\sqrt{{r}_{0}^{2} - {x}^{2} - {y}^{2}} ⅆ x ⅆ y}{\sqrt{{( {x}_{o} - x )}^{2} + {( {y}_{o} - y )}^{2} + {z}_{o}^{2}}} \qquad ( 49 )$$

For xₒ=y ₒ=O; r=zₒ,

$$Φ ( r ) = \frac{e}{4 π {ϵ}_{O} r} \qquad ( 50 )$$

For r=\sqrt{xₒ²+yₒ²+zₒ²}>>rₒ,

$$Φ ( r ) = \frac{e}{4 {πϵ}_{O} r} \qquad ( 51 )$$

Eqs. (50) and (51) are equivalent to the potential of a point charge at the origin. The electric field, ε, is the gradient of the electric potential given by Eqs. (49-51)

ε=−∇Φ (52)

Pseudoelectrons.

The elastic electron scattering in the far field is given by the Fourier Transform of the aperture function as described in Derivation of Electron Scattering by Helium Section [The Unification of Spacetime, the Forces, Matter, and Energy, Mills, R., Technomic Publishing Company, Lancaster, Pa., (1992)]. The convolution of a uniform plane wave with on orbitsphere of radius zₒ is given by Eq. (4.43) and Eq. (4.44) of Mills [The Unification of Spacetime, the Forces, Matter, and Energy, Mills, R., Technomic Publishing Company, Lancaster, Pa., (1992)].

A(r), the aperture distribution function, for the scattering of an incident plane wave by the He atom is given by the convolution of the plane wave function with the two electron orbitsphere Dirac delta function of radius=0.567 aₒ and charge/mass density of

$$\frac{2}{4 {π ( 0.567 {a}_{o} )}^{2}} \cdot For radial units in term s of {a}_{o} \\ a ( r , θ , z ) = π ( z ) * \frac{2}{4 {π ( 0.567 {a}_{o} )}^{2}} [ δ ( r - 0.567 {a}_{o} ) ] \qquad ( 53 )$$

where a(r,θ,z) is given in cylindrical coordinates, the plane wave, represented by π(z), is given in Cartesian coordinates with the propagation direction along the z axis, and the orbitsphere function is given in spherical coordinates.

$$a ( r , θ , z ) = \frac{2}{4 {π ( 0.567 {a}_{o} )}^{2}} \sqrt{{( 0.567 {a}_{o} )}^{2} - {z}^{2}} δ ( r - \sqrt{{( 0.567 {a}_{o} )}^{2} - {z}^{2}} ) \qquad ( 54 )$$

The convolution of the charge density equation of a free electron given by Eq. (24) with an orbitsphere of radius zₒ follows from Eq. (24) and Eq. (54)

$$a ( r , θ , z ) = \sqrt{{r}_{o}^{2} - {r}^{2}} \sqrt{{z}_{o}^{2} - {z}^{2}} δ ( r - \sqrt{{z}_{o}^{2} - {z}^{2}} ) \qquad ( 55 )$$

Substitution of Eq. (55) into Eq. (4.45) of Mills [The Unification of Spacetime, the Forces, Matter, and Energy, Mills, R., Technomic Publishing Company, Lancaster, Pa., (1992)] gives

$$F ( s ) = \frac{1}{{z}_{o}^{2}} {\int }_{- {z}_{o}}^{{z}_{0}} \sqrt{{r}_{o}^{2} - ( {z}_{o}^{2} - {z}^{2} )} ( {z}_{o}^{2} - {z}^{2} ) {J}_{o} ( s \sqrt{{z}_{o}^{2} - {z}^{2}} ) ) {ⅇ}^{- ⅈ wz} ⅆ z \qquad ( 56 )$$

Substitution

$$\frac{z}{{z}_{o}} = - cos θ$$

into Eq. (56) gives

$$F ( s ) = {\int }_{0}^{π} \sqrt{{r}_{o}^{2} - {z}_{o}^{2} {sin}^{2} θ} {sin}^{3} θ {J}_{o} ( {sz}_{o} sin θ ) {ⅇ}^{{ⅈz}_{o} w cos θ} ⅆ θ \qquad ( 57 )$$

when rₒ=zₒ, Eq. (57) becomes

$$F ( s ) = {z}_{o} {\int }_{0}^{π} cos θ {sin}^{3} θ {J}_{o} ( {sz}_{o} sin θ ) {ⅇ}^{ⅈ {z}_{o} w cos θ} ⅆ θ \qquad ( 58 )$$

The function of the scattered electron in the far field is given by the Fourier Transform integral, Eq. (57). Eq. (57) is equivalent to the Fourier Transform integral of cosθ times the Fourier Transform integral given by of Eq. (4.47) of Mills [The Unification of Spacetime, the Forces, Matter, and Energy, Mills, R., Technomic Publishing Company, Lancaster, Pa., (1992)] with the result given by Eq. (4.50) of Mills [The Unification of Spacetime, the Forces, Matter. and Energy, Mills, R., Technomic Publishing Company, Lancaster, Pa., (1992)]. A very important theorem of Fourier analysis states that the Fourier Transform of a product is the convolution of the individual Fourier Transforms. Thus, given that

Z=Zₒcosθ (59)

and the Fourier Transform of cosθ is

$$\frac{[ δ ( Θ - {Θ}_{o} ) + δ ( Θ + {Θ}_{o} ) ]}{2} \qquad ( 60 )$$

The Fourier Transform integral, Eq. (57), is the convolution of Eq. (4.50) of Mills [The Unification of Spacetime, the Forces, Matter, and Energy, Mills, R., Technomic Publishing Company, Lancaster, Pa., (1992)] and Eq. (60). And, the result of this convolution is the mass density function of each electron having a de Broglie wavelength given by

$${λ}_{o} = \frac{h}{{m}_{e} {v}_{z}} = 2 π {r}_{o} \qquad ( 61 )$$

where rₒ is the radius of the free electron in the z plane, the plane perpendicular to its direction of propagation. The velocity of each electron follows from Eq. (61)

$${v}_{z} = \frac{h}{{m}_{e} {λ}_{o}} = \frac{h}{{m}_{e} {2}_{π} {r}_{o}} = \frac{ℏ}{{m}_{e} {r}_{o}} \qquad ( 62 )$$

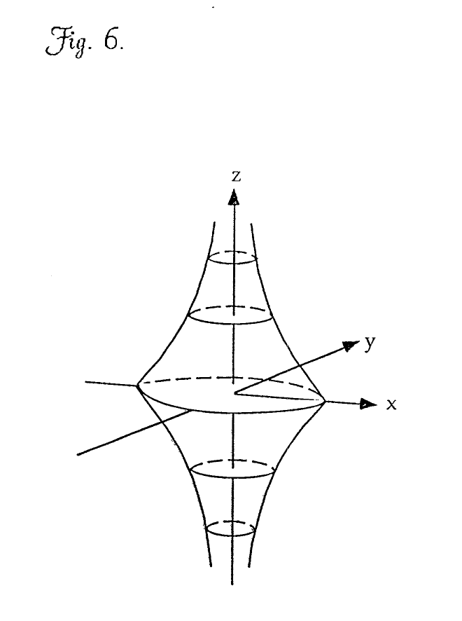

For the special case that Eqs. (61) and (62) are satisfied, the mass density function of the electron which is elastically scattered by an atom having a radius of zₒ is a pseudosphere. The magnetic field of the current density function of the pseudospherical electron (pseudoelectron) provides the force balance of the centrifugal force of the mass density function as was the case for the free electron. Pseudoelectrons can be focussed into a beam by electric and/or magnetic fields to form a pseudoelectron beam. A pseudoelectron having a pseudospherical-shaped mass density function is shown in FIG. 6.

In a preferred embodiment, the neutral atoms of the neutral atom beam comprises helium, and the velocity of the free electrons of the electron beam is

$${v}_{z} = \frac{ℏ}{{m}_{e} {r}_{o}} = 3.858361 \times {10}^{6} m / s \qquad ( 63 )$$

where rₒ=0.567aₒ=3.000434 ×10⁻¹¹ m

In another preferred embodiment, the each atom of the neutral atomic beam comprises hydrogen atom H (ₙ/¹; rₒ=ₙ/^{a} ^{₀}; is an integer) as described in my previous U.S. Patent Application No. 08/075,102 entitled “Energy/Matter Conversion Methods and Structures” filed on Jun. 11,1993 and my previous U.S. Patent Application No. 08/107,357 entitled “Energy/Matter Conversion Methods and Structures” filed on Aug. 16,1993 which are incorporated herein by reference. The velocity of each electron of the free electron beam is

$${v}_{z} = \frac{ℏ}{{m}_{e} {r}_{o}} = 2.187691 \times {10}^{6} m / s \\ where \\ {r}_{o} = \frac{{a}_{o}}{n} = \frac{5.29177 \times {10}^{- 11} m}{n} \qquad ( 64 )$$

For a nonrelativistic electron of velocity v_{z}, the kinetic energy, E_{T}, is

$${E}_{T} = \frac{1}{2} {m}_{e} {v}_{z}^{2} \qquad ( 65 )$$

In the case of helium with the substitution of Eq. (63) into Eq. (65),

E_{T}=42.3 eV (66)

In the case of hydrogen with the substitution of Eq. (64) into Eq. (65),

E_{T}=n²13.6 eV (67)

Antigravity Device.

Antigravity can be created by forcing matter into negative curvature. A fundamental particle with negative curvature would experience a central but repulsive force with a gravitating body comprised of matter of positive curvature. The antigravity force is the basis of a propulsive means. The propulsive means comprises a source of fundamental particles such as electrons (which are leptons) where the fundamental particles are forced to be plane waves of matter by the absorption of energy. For example, a bound electron is ionized to a plane wave by the absorption of the ionization energy. The plane waves of matter are accelerated and formed (or warped) into negative curvature by one or more of an electric field, a magnetic field or an electromagnetic field such as a laser beam applied parallel or transversely to the plane wave of matter or such as an evanescent field produced by a totally internally refracted electromagnetic wave traveling in a fiberoptic cable.

The antigravity force which arises is transferred to the source means of the fields and is further transferred to the structure to be accelerated or levitated due to the latter means rigid attachment to the structure.

Further according to the present invention, negatively curved matter is created by ionizing fundamental particles to become plane waves. The ionization energy can be provided by applying a large potential to or by heating or irradiating a cathode. In the latter case, photocathodes irradiated with continuous wave or pulsed lasers can generate very bright, high current density beams of electrons. Photocathodes, thermionic cathodes, and cold cathodes are described by Orttinger, P., et al., Nuclear Instruments and Methods in Physics Research, A272, 264-267 (1988) and Sheffield, R., et al., ibid, 222-226 which are incorporated herein by reference. The resulting plane waves are caused to propagate through space and to acquire negative curvature by traversing a selected field as created by a field source means. The field source means provides one or more of an electric field, a magnetic field, or an electromagnetic field. The resulting current density function is three-dimensional (two spatial dimensions plus time) and is a solution to the three-dimensional wave equation that follows:

$$( {∇}^{2} - \frac{1}{{V}^{2}} \frac{{δ}^{2}}{δ {t}^{2}} ) A ( x , y , z , t ) = 0 \qquad ( 68 )$$

Furthermore, the negatively curved fundamental particle including an electron propagates through space and is decelerated by the antigravity force with a gravitating body and is accelerated by the propagation force provided by the source means. The resulting negative curvature which arises from the forces acting on the matter is such that its spacetime Fourier transform does not possess waves synchronous with those traveling at the speed of light.

Matter of negative curvature which moves at constant velocity has a spacetime Fourier transform which does not possess Fourier components synchronous with waves traveling at the speed of light Consider the mass density function which travels in the z direction

$$δ [ z - f ( x ) g ( y ) - K ( t ) ] \qquad ( 69 )$$

where

K(t)=vt (70)

and where the velocity v is a constant. The spacetime Fourier transform is given as follows:

F(kₓ) G(k_{y})δ(w −k ·v) (71)

where F(kₓ) and G(k_{y}) is the Fourier transform of f(x) and g(y), respectively. The only nonzero Fourier components are for

$$k = \frac{w}{v cos θ} > \frac{w}{c} \qquad ( 72 )$$

where θ is the angle between v and k. Thus, the spacetime Fourier transform has no components synchronous with waves at the speed of light; therefore, the particle is nonradiative. For example, the Fourier transform of the current density function

$$δ [ z - x ( z ) y ( z ) - {v}_{z} t ] \qquad ( 73 )$$

is given as follows:

$$\frac{π / 2}{{k}_{z}} {e}^{- {k}_{x} {k}_{y} / {k}_{z}} δ ( w - k \cdot \overline{v} ) \qquad ( 74 )$$

which has no components synchronous with waves traveling at the speed of light; thus, it is nonradiative.

In a further embodiment the mass density function is given by Eq. (73) where v_{z} is constant velocity in the z direction at force balance. The mass density function is produced by a quadrapole electric field at infinity or a quadrapole magnetic field at infinity, and a constant force of equal magnitude and opposite direction of the antigravity force; thus, the matter of negative curvature moves with constant velocity v_{z}.

### THE EMBODIMENT

In one embodiment according to the present invention, the apparatus for providing the antigravitational force comprises a means to inject electron plane waves and a guide means to guide the propagation of the plane waves. Acceleration and forming negative curvature is effected in the propagating guided electrons by application of one or more of an electric field, a magnetic field, or an electromagnetic field by a field source means. A repulsive force of interaction is created between the propagating electrons of negative curvature and the gravitational field of a gravitating body which comprises matter of positive curvature where the field source means provides an equal and opposite force to the repulsive force. Thus, the interactive force is transferred to the field source and the guide which further transfers the force to the attached structure to be accelerated.

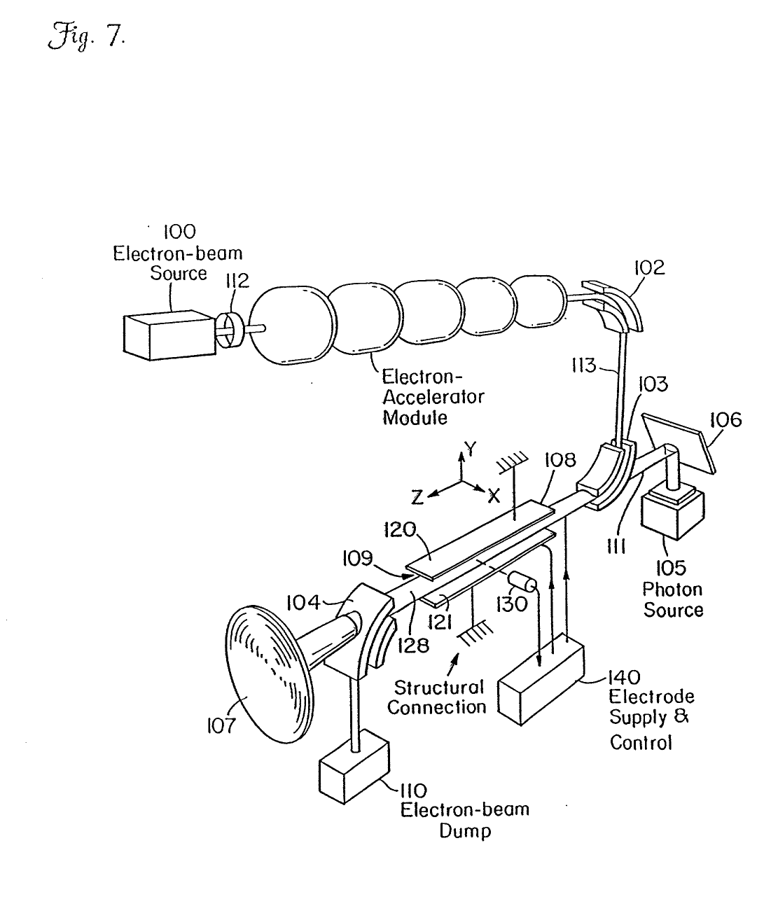

In the embodiment, the antigravity means shown schematically in FIG. 7 comprises an electron beam source 100, and an electron accelerator module 101, such as an electron gun, an electron storage ring, a radio frequency linac, an introduction linac, an electrostatic accelerator, or a microtron. The beam is focused by focusing means 112, such as a magnetic or electrostatic lens, a solenoid, a quadrapole magnet, or a laser beam. The electron beam 113, is directed into a channel of electron guide 109, by beam directing means 102 and 103, such as dipole magnets. Channel 109, comprises a field generating means to produce a constant electric or magnetic force in the direction opposite to direction of the antigravity force. For example, given that the antigravity force is negative z directed as shown in FIG. 7, the field generating means 109, provides a constant z directed electric force due to a constant electric field in the negative z direction via a linear potential provided by grid electrodes 108 and 128; given that the antigravity force is positive y directed as shown in FIG. 7, the field generating means 109, provides a constant negative y directed electric force due to a constant electric field in the negative y direction via a linear potential provided by the top electrode 120, and bottom electrode 121, of field generating means 109. Given that the antigravity force is positively directed, the field generating means 109, provides a constant negative y directed magnetic force due to a constant dipole magnetic field in the x direction for an electron beam traveling in the z direction.

In one embodiment the field generating means 109, further provides an electric or magnetic field at infinity which warps the electrons of the electron beam 113, into negative curvature to produce the antigravitational force with a gravitating body. In a further embodiment the electric potential of the warping electric field is given as follows:

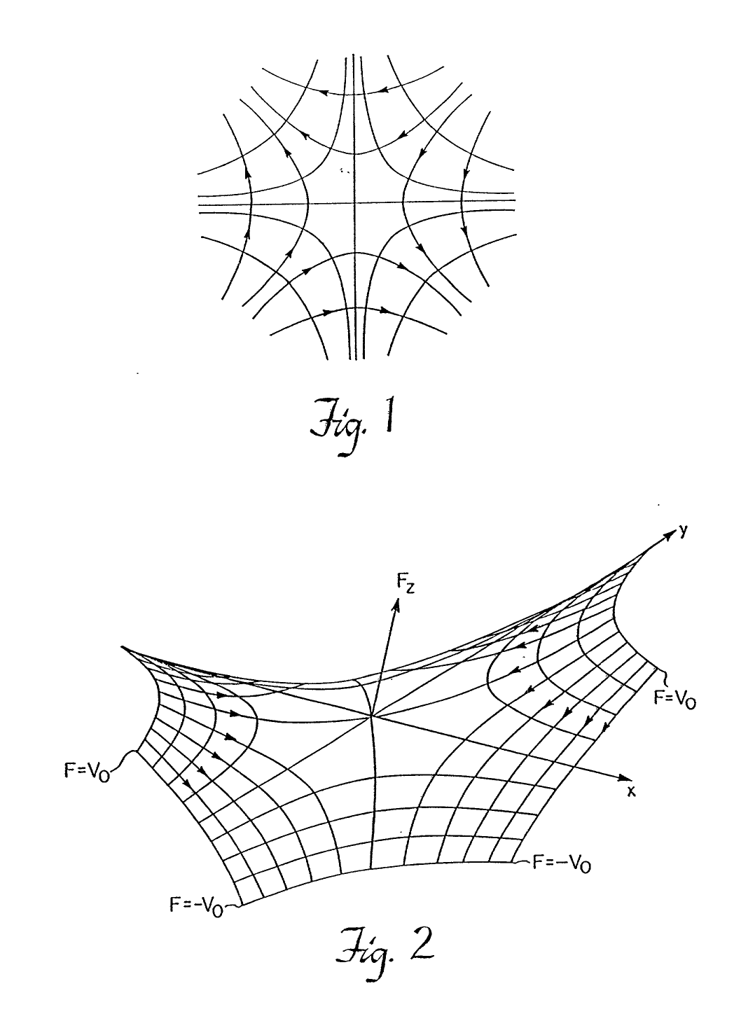

xyz+cp (75)

where c is a constant and p is either x, y, or, z and is the direction opposite the force of antigravitation; so, the corresponding electric force on the electron is opposite the antigravitational force as described previously. The electric field is given by the negative of the gradient of the potential. The electric warping force in the z direction is shown in FIG. 2. In a further embodiment the magnetic potential of the warping field is given as follows:

xy+cp (76)

where c is a constant and p is either x, y, or z so that the corresponding constant dipole magnetic field produces a constant magnetic force in the direction opposite to the force of antigravity as described previously. The potential function and field lines are shown in FIG. 1. The magnetic field is given by the negative gradient of the potential. The z directed warping force on an electric plane wave propagating in the positive z direction is shown in FIG. 2.

The electric and magnetic warping fields force the electron plane wave into negative curvature given as follows:

$$δ [ z - x ( z ) y ( z ) - {v}_{z} t ] \qquad ( 77 )$$

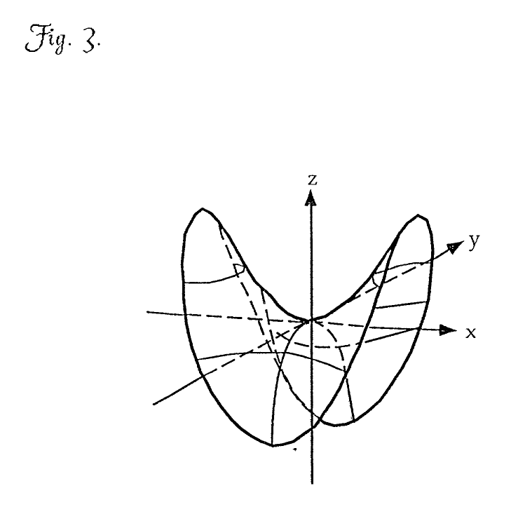

This mass density function is shown schematically in FIG. 3.

The velocity, v, of the electron is a constant due to the equality of the constant electric or magnetic force and the antigravitational force which arises as an interaction between the gravitating body and the electron of negative curvature. The constant force provides constant levitation or propagation work against the gravitational field of the gravitating body as the fundamental particle including an electron propagates along the channel of the guide means and field producing means 109. The resulting work is transferred to the means to be propelled or levitated via its attachment to field producing means 109.

The constant electric or magnetic force is variable until force balance with the antigravitational force is achieved. In the absence of force balance, the electrons will be accelerated and the emittance of the beam will increase. Also, the accelerated electrons will radiate; thus, the drop in emittance and/or the absence of radiation is the signal that force balance is achieved. The emittance and/or radiation is detected by sensor means 130, such as a photomultiplier tube, and the signal is used in a feedback mode by analyzer-controller 140 which varies the constant electric or magnetic force by controlling the potential or dipole magnets of (field producing) means 109 to control force balance to maximize antigravitational work.

In another embodiment the negative curvature of the electrons of the electron beam 113 is produced by the absorption of photons provided by a photon source 105, such as a high intensity photon source, such as a laser. The laser radiation can be confined to a resonator cavity by mirrors 106 and 107.

In a further embodiment, electrons from the electron beam 113 are warped into negative curvature by inelastic scattering with photons from the photon source 105. The laser radiation or the resonator cavity is oriented relative to the propagation direction of the electron plane wave such that the inelastic scattering cross section of the electron with the photon to yield negatively curved electrons is maximized for radiation of a given multipolarity. For example, given (that) the direction of propagation of the beam 113 is in the z direction of FIG. 7, and the radiation is of multipolarity M1 (magnetic quadrapole radiation) or E₂ (electric quadrapole radiation), then the preferred orientation of the laser radiation or resonator cavity is along the given the direction of propagation of the beam 113, the z direction. In this case the cross section to yield saddle-shaped electrons is maximized.

Following the propagation through field generating means 109 in which antigravity work is extracted from the beam 113, the beam 113, is directed by beam directing apparatus 104, such as a dipole magnet into electron-beam dump 110.

In a further embodiment, the beam dump 110 is replaced by a means to recover the remaining energy of the beam 113 such as a means to recirculate the beam or recover its energy by electrostatic deceleration or deceleration in a radio frequency-excited linear accelerator structure. These means are described by Feldman, D. W., et al., Nuclear Instruments and Methods in Physics Research, A259, 26-30 (1987) which is incorporated by reference.

The present invention comprises high current and high energy beams and related systems of free electron lasers. Such systems are described in the following references which are incorporated herein by reference:

Nuclear Instruments and Methods in Physics Research, A272, (1,2), 1-616 (1988)

Nuclear Instruments and Methods in Physics Research, A259, (1,2), 1-316 (1987)

In one embodiment shown in FIG. 11, the HECTER reactor 210 described in my previous U.S. patent applications entitled “Energy/Matter Conversion Methods and Structures”, Ser. No. 08/107,357 filed on Aug. 16, 1993 provides heat which is converted to steam in heat exchanger 214. The steam is transferred by connection 216 to turbine 218 which is driven by the steam to produce electricity to supply the electrical load of the antigravity apparatus 224. Alternatively, the heat is transferred by connection 212 to thermionic power converter 226 which directly converts the heat to electricity to supply the electrical load of the antigravity apparatus 224, where the unused heat is returned via connection 213. The electrical energy is converted into antigravitational energy by antigravity apparatus 228 which provides propulsion and levitation to the vehicle to which the antigravity apparatus 228 is structurally attached by structural connection 206. The HECTER reactor 210, the heat exchanger 214, the turbine 218, the power generator 220, and the thermionic power converter 226, are also propelled or levitated with the vehicle by their respective structural connections 201-206 to the vehicle.

An electron as a plane wave is accelerated by the force of an electric field, and a nonradiative electron current density function of negative curvature moves at constant velocity and exists when the forces of absorbed photons, shaping/warping forces, the propagation acceleration forces, and the repulsive gravitational force between the electron and a gravitating body comprising matter of opposite (positive) curvature exactly balance. The electron does constant antigravity work as it propagates along the guide where the gravitating body's and the electron's curvatures are essentially constant over the time of interaction of the gravitational forces.

For a propagation electric field strength of 109 V/m and a gravitational interaction of 1 meter, the antigravity work of the electron is 1 GeV.

The propulsion power available for guide or a series of guides (109 of FIG. 7) carrying a total of 1000 Amps with a repulsive gravitational interaction force-distance product per electron of 1 GeV is given as follows:

$$\frac{{10}^{9} ev}{electron} \times 1.6 {( 10 )}^{- 19} J / ev \times 1000 c / sec \times \frac{1 electron}{1.6 {( 10 )}^{- 19} c} = {10}^{12} J / sec = one terawatt$$

The time to accelerate a structure such as a vehicle having a mass of 500,000 kg to a velocity of 1000 m/sec is given as follows:

$$\frac{1}{2} \times 500 \text{,} 000 \times {( 1000 m \text{/} sec )}^{2} = 2.5 \times {10}^{11} J \frac{2.5 \times {10}^{11}}{{10}^{12} J \text{/} sec} = .250 seconds = 250 milliseconds .$$

.250 seconds=250 milliseconds. Thus, the antigravity force produced by the antigravity apparatus according to the present invention can be applied to accelerate large vehicles or to levitate any large object.

In a further embodiment, the force provided by the antigravity apparatus according to the present invention is central with respect to the gravitating body. However, acceleration in a direction tangential to the gravitating body's surface can be effected via conservation of angular momentum. Thus, a centrally accelerated structure such as an aerospace vehicle to be tangentially accelerated possesses a cylindrically or spherically symmetrically movable mass having a moment of inertia, such as a flywheel device. The flywheel is driven ; with angular motion by a driving device such as an electric motor which is powered by an electric energy source means such as a HECTER reactor with a thermionic or steam generator, or batteries. The driving device provides angular momentum to the flywheel. The vehicle is levitated using antigravity means to overcome the gravitational force of the gravitating body where the levitation is such that the angular momentum vector of the flywheel is parallel to the central vector of the gravitational force of the gravitating body. The angular momentum vector of the flywheel is forced to make a finite angle with the central vector of gravitational force by tuning the symmetry of the levitating (antigravitational) forces provided by antigravity apparatus. A torque is produced on the flywheel as the angular momentum vector is reoriented with respect to the central vector due to the interaction of the central force of gravity of the gravitating body, the force of antigravity of the antigravity means, and the angular momentum of the flywheel device. The resulting acceleration which conserves angular momentum is perpendicular to the plane formed by the central vector and the angular momentum vector. Thus, the resulting acceleration is tangential to the surface of the gravitating body.

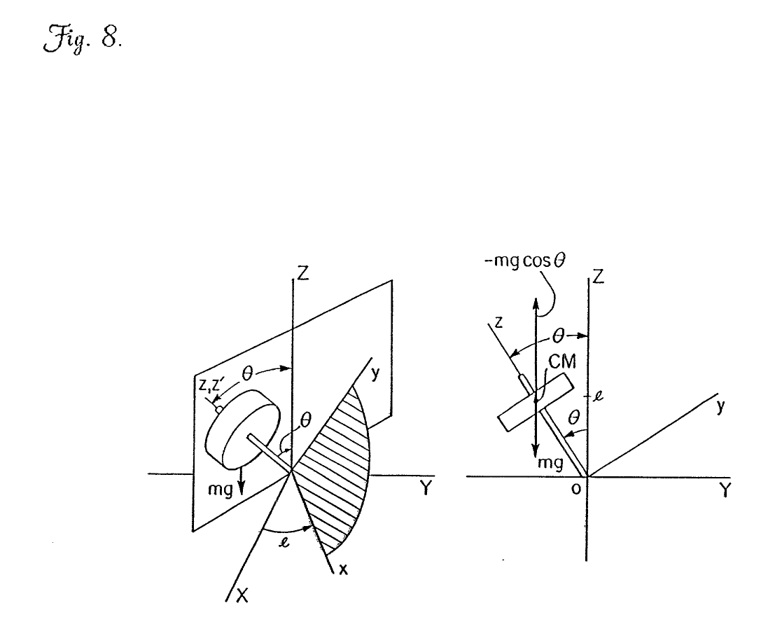

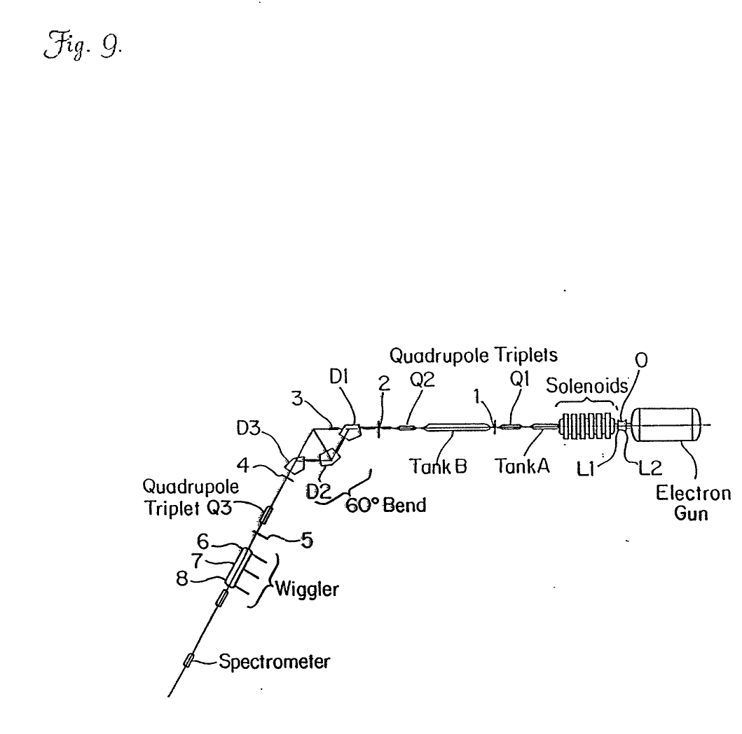

The equation that describes the motion of the vehicle with a moment of inertia I, a spin, moment of inertial Iₛ, a total mass m, and a spin frequency of its flywheel device of S is given as follows:

$$S = \frac{mg 1}{{I}_{S} \dot{φ}} + \frac{I}{{I}_{S}} \dot{φ} cos θ \qquad ( 78 )$$

$$\dot{φ} ≅ \frac{mg 1}{{I}_{S} S} ≅ \frac{mg 1}{{mr}^{2} S} = \frac{g 1}{{r}^{2} S} \qquad ( 79 )$$

where θ is the tilt angle between the central vector and the angular momentum vector, g is the acceleration due to gravity of the gravitating body, I is the height to which the vehicle levitates, and φ is the angular procession frequency resulting from the said torque. The schematic appears in FIG. 8.

A calculation of the approximate velocity achieved when the vehicle's angular momentum vector is tilted 45° with respect to the central vector is given as follows where g=10 m/sec², 1=5000 m, r=10 m, S=25 sec⁻¹

$$\dot{φ} ≅ \frac{g 1}{{Sr}^{2}} = \frac{( 10 ) ( 5000 )}{( 25 ) {( 10 )}^{2}} = \frac{20 cycles}{second} \qquad ( 80 )$$

The linear velocity is the radius times the angular frequency which is given as follows:

2 π20 cycles/second (5000 m)sin(45° )=4.4×10⁵ m/sec (81)

This calculation indicates that large tangential velocities are achievable by executing a trajectory which is vertical followed by tangential (velocities) where the latter motion is effected by tilting the flywheel. During the tangential acceleration energy stored in the flywheel is converted to kinetic energy of the vehicle. The equation for rotational kinetic energy E_{R} and transitional kinetic energy E_{T} are given as follows:

E_{R} =1/2I ω² (82)

where I is the moment of inertia and ω is the angular rotational frequency;

E_{T}=1/2 mv² (83)

where m is the total mass and v is the transitional velocity. The equation for the moment of inertia I of the flywheel is given as:

I=Σmr² (84)

where m is the infintesimal mass at a distance r from the center of mass. These equations demonstrate that maximum rotational kinetic energy can be stored for a given mass by maximizing the distance of the mass from the center of mass. Thus, ideal design parameters are cylindrical symmetry with the rotating mass at the perimeter of the vehicle.

Furthermore, according to the methods and apparatus of the present invention providing antigravitational forces, rapid long distance transport may be realized where the propelled means, such as a space vehicle, is accelerated to enormous velocity by executing a hyperbolic trajectory around a gravitating body wherein the force of gravity of the gravitating body and the antigravity force of the vehicle provided by the antigravity means of the present invention accelerate the vehicle to high velocity.

### EXPERIMENTAL I

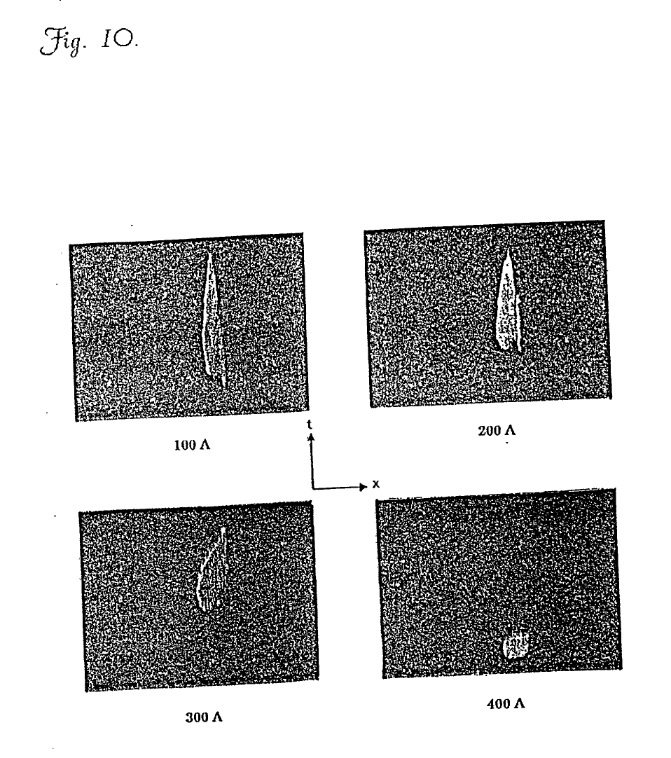

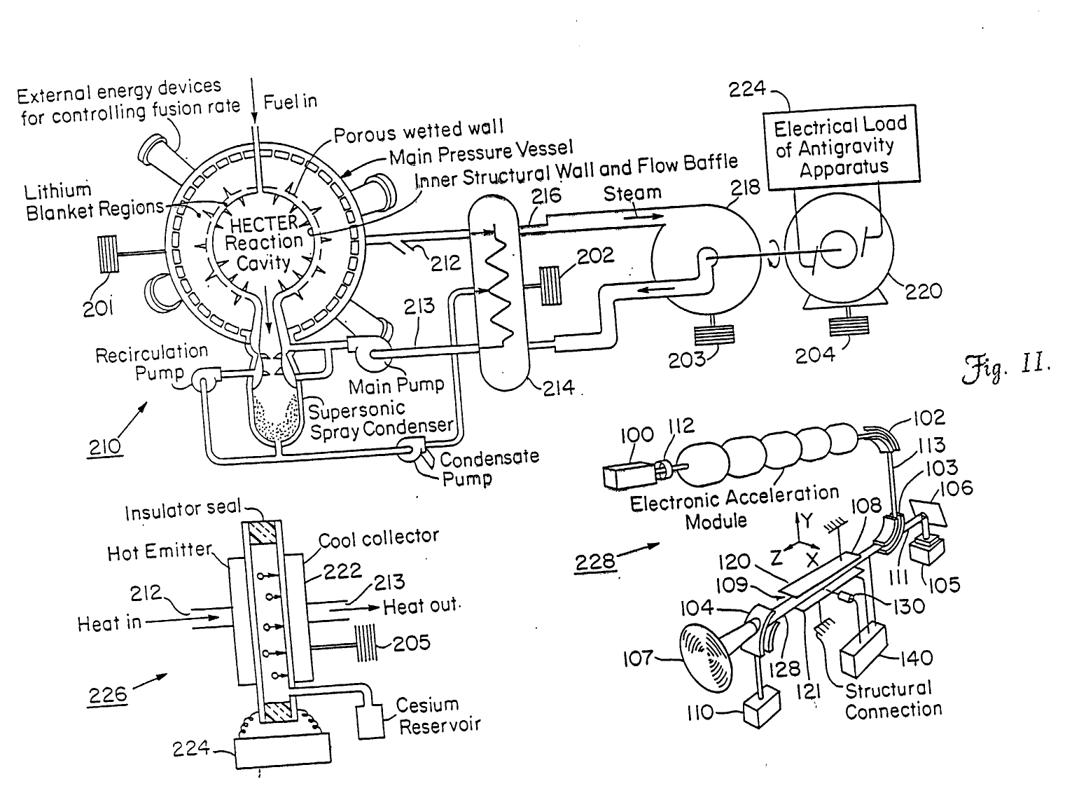

A high current, high energy electron beam was injected into a quadrapole magnetic field, and the geometric cross-sectional profile of the beam was recorded by Carlsten [Carlsten, B. E.; et al., Nuclear Instruments and Methods in Physics Research, A272, 247-256 (1988)]. One embodiment of the antigravity propulsion and levitation means of the present invention comprises the apparatus of FIG. 9 with the absence of the wiggler and the spectrometer. But, in addition the device of the present invention comprises an electron guide means comprising a channel for the electron beam and a field generating means 109 of FIG. 7, to produce a constant electric or magnetic force against the antigravitational force produced on the electrons of negative curvature following their propagation through the quadrapole triplets, Q₁, Q₂, and Q₃ of FIG. 9. Unharnessed antigravity was achieved as demonstrated by the flame shape of the beam which is a function of current as shown in FIG. 10. (which is FIG. 11 of the reference). The data indicate that a Boltzmann distribution of negative curvature was achieved as is apparent by the flame shape of the beam profile (see FIG. 10). The shape is due to the constant gravitational field of the Earth interacting with a Boltzmann distribution of electrons of negative curvature resulting in a Boltzmann distribution of antigravitational forces and corresponding displacements. The maximum vertical deflection of the relativistic electrons by the antigravitational forces is approximately 5 centimeters over a displacement in the direction of the electron beam of 50 centimeters. Thus, antigravitational forces comparable to the electrostatic and electromagnetic forces of the apparatus were achieved. The current dependence of the efficiency of negative curvature production resulted from increased electron-electron interactions with higher beam current which prevented efficient coupling of the electrons with the quadrapole triplets. However, significant antigravity was produced at currents of several hundred amperes. Thus, the present experiment indicates that antigravitational work of the order of 1 GeV per electron is achievable by the methods and apparatus of the present invention.

Preferred Embodiment of An Antigravity Device.

A method and means to produce an antigravitational force for propulsion and/or levitation comprises a source of fundamental particles including electrons and a source of neutral atoms. The source of electrons produces a free electron beam, and the source of neutral atoms produces a free atom beam. The two beams intersect such that the neutral atoms cause elastic incompressible scattering of the electrons of the electron beam to form pseudoelectrons. In a preferred embodiment, the de Broglie wavelength of each electron is given by

$${λ}_{o} = \frac{h}{{m}_{e} {v}_{z}} = {2}_{π} {r}_{o} \qquad ( 85 )$$

where rₒ is the radius of the free electron in the x-y plane, the plane perpendicular to its direction of propagation. The velocity of each electron follows from Eq. (85)

$${v}_{z} = \frac{h}{{m}_{e} {λ}_{o}} = \frac{h}{{m}_{e} {2}_{π} {r}_{o}} = \frac{ℏ}{{m}_{e} {r}_{o}} \qquad ( 86 )$$

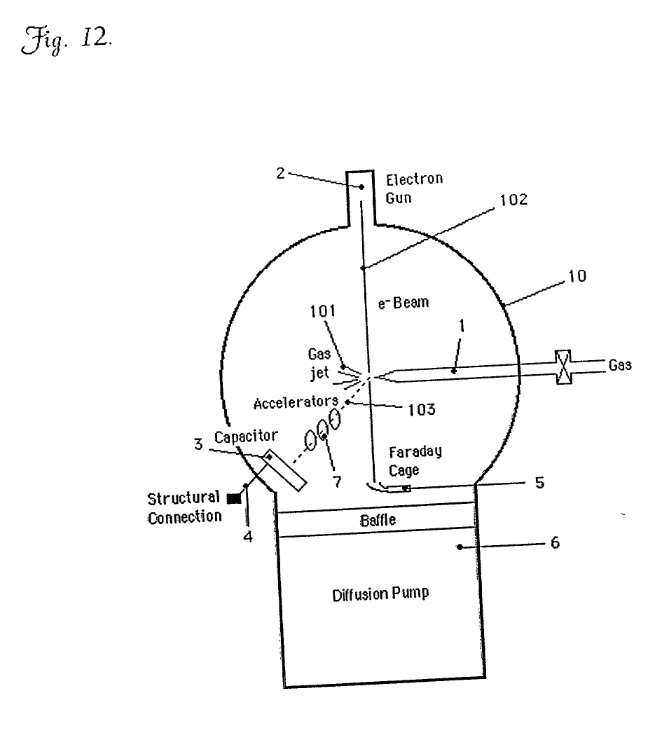

As shown schematically in FIG. 12, a device 10 to provide an antigravitational force for levitation or propulsion comprises a source 1 of a gas jet of atoms 101 such as helium atoms such as described by Bonham [Bonham, R. F., Fink, M., High Energy Electron Scattering, ACS Monograph, Van Nostrand Reinhold Company, New York, (1974)] and an energy tunable electron beam source 2 which supplies an electron beam 102 having electrons of a precise energy such that the radius of each electron is equal to the radius of each atom of the gas jet 101. Such a source is described by Bonham [Bonham, R. F., Fink, M., High Energy Electron Scattering, ACS Monograph, Van Nostrand Reinhold Company, New York, (1974)]. The gas jet 101 and electron beam 102 intersect such that each electron is elastically scattered and warped into a pseudosphere of negative curvature (pseudoelectron). The pseudoelectron beam 103 passes into an electric field provided by a capacitor means 3. The pseudoelectrons experience an antigravitational force due to their negative curvature and are accelerated away from the center of the gravitating body such as the Earth. This upward force is transferred to the capacitor means 3 via a repulsive electric force between the pseudoelectrons and the electric field of the capacitor means 3. The capacitor means 3 is rigidly attached to the body to be levitated or propelled by the structural connection 4. The present antigravity means further includes a means to trap unscattered and pseudoelectrons and recirculate them through the beam 102. Such a trap means 5 includes a Faraday cage as described by Bonham [Bonham, R. F., Fink, M., High Energy Electron Scattering, ACS Monograph, Van Nostrand Reinhold Company, New York, (1974)]. The present antigravity means 10 further includes a means 6 to trap and recirculate the atoms of the gas jet 101. Such a gas trap means 6 includes a pump such as a diffusion pump as described by Bonham [Bonham, R. F., Fink, M., High Energy Electron Scattering, ACS Monograph, Van Nostrand Reinhold Company, New York, (1974)].

In the case of a sphere, surfaces of constant potential are concentric spherical shells. The general law of potential for surfaces of constant curvature is

$$V = \frac{1}{4 {πϵ}_{o}} \sqrt{\frac{1}{{r}_{1} {r}_{2}}} = \frac{1}{4 {πϵ}_{o} R} \qquad ( 87 )$$

In the case of a pseudosphere, the radii r₁, and r₂, the two principal curvatures, represent the distances measured along the normal from the negative potential surface to the two sheets of its evolute, envelop of normals (cantenoid and x-axis). The force is given as the gradient of the potential which is proportional to 1/r₂ in the case of a sphere. However, for a pseudosphere having a curvature of equal magnitude but opposite sign, the electric force is much greater. The pseudoelectron mass density function is equivalent to the charge density function. The solutions to Einstein's field equations for the force on a particle are also a function of spatial derivatives of the mass density function. Thus, the antigravitational force on a pseudoelectron by a gravitating body is much greater than the force on an electron orbitsphere by the same body. Thus, significant lift is possible using pseudoelectrons.

The force generated by the antigravity levitation and propulsion means can be calculated rigorously by solving Einstein's field equations as a boundary value problem for a two-dimensional spatial mass density function of negative curvature which is produced by the apparatus. However, forces in the limit can be obtained as follows. Consider a negative solution to the variable a of Eq. (57.37) given by Fock [Fock, V., The Theory of Space, Time, and Gravitation, The MacMillan Company, (1964)]. The negative solution arises naturally as a match to the boundary condition of matter with negative curvature. Furthermore, matter having negative curvature would occupy a diminished quantity of four-dimensional spacetime, as compared to matter of positive curvature. The surface to volume ratio of a sphere is a minimum. In effect, μ of Eq. (57.38) given by Fock [Fock, V., The Theory of Space. Time. and Gravitation, The MacMillan Company, (1964)] would increase. Consequently, the integral of Eq. (57.37) is approximately of the form

$$\frac{{m4πρ}^{2}}{s} \qquad ( 88 )$$

where s is the space defined by the boundaries of the matter of negative curvature. The presence of a three-dimensional spacetime current density function in four-dimensional spacetime results in curved nonlocal spacetime which is the origin of gravity. For the case of negative curvature, the antigravity force with a gravitating body can be increased by increasing the intensity of negative curvature.

The antigravitational force of pseudoelectrons can be increased by using atoms of the neutral atom beam of relativistic kinetic energy. The electrons of the electron beam and the relativistic atoms of the neutral atomic beam intersect at an angle such that the relativistically contracted radius of each atom, zₒ, is equal to rₒ, the radius of each free electron of the electron beam. Elastic scattering produces pseudoelectrons at relativistic energies. The relativistic radius of helium is calculated by substitution of the relativistic mass (Eq. (14.11 of Mills [The Unification of Spacetime, the Forces, Matter, and Energy, Mills, R., Technomic Publishing Company, Lancaster, Pa., (1992)])) of helium

$$m = \frac{{m}_{0}}{\sqrt{1 - \frac{{v}^{2}}{{c}^{2}}}} \qquad ( 89 )$$

into Eq. (3.19) of Mills [The Unification of Spacetime, the Forces, Matter, and Energy, Mills, R., Technomic Publishing Company, Lancaster, Pa., (1992)]. In a further embodiment, the relativistic atomic beam which intersects the electron beam directed along the negative x axis is oriented at an angle of π/4 to both the xz and yz planes with the relativistic radius of each neutral atom equal to the radius of each free electron.

In another further embodiment shown in FIG. 12, pseudoelectrons are accelerated to relativistic energies by an acceleration means 7 before entering the capacitor means 3 to provide relativistic pseudoelectrons with increased energy to be converted to gravitational potential energy as the body to be levitated is levitated.

In another further embodiment shown in FIG. 12, pseudoelectrons of relativistic energy are produced by the inelastic incompressible scattering of relativistic electrons of the electron beam 102 from the beam of neutrons 101 from the neutron source 1. The relativistic radius of each electron equals the radius, r_{N}, of the neutron given by Eq. (15.15) of Mills [The Unification of Spacetime, the Forces, Matter, and Energy, Mills, R., Technomic Publishing Company, Lancaster, Pa., (1992)].

$${r}_{N} = \frac{h}{{m}_{N} c} \qquad ( 90 )$$

where m_{N} is the mass of the neutron. The relativistic electron velocity is calculated from Eq. (62) and Eq. (90) where the mass of the electron is relativistically corrected by substitution of the mass given by Eq. (89) into Eq. (62).

$${v}_{z} = \frac{ℏ}{\frac{{m}_{e}}{\sqrt{1 - \frac{{v}^{2}}{{c}^{2}}}} {r}_{N}} = c \sqrt{\frac{1}{1 + {[ 2 π \frac{{m}_{e}}{{m}_{N}} ]}^{2}}} = .9999942 c \qquad ( 91 )$$

The relativistic kinetic energy, E_{T}, is

$${E}_{T} = {m}_{e} {c}^{2} ( \frac{1}{\sqrt{1 - \frac{{v}^{2}}{{c}^{2}}}} - 1 ) \qquad ( 92 )$$

In the case of neutrons with the substitution of Eq. (91) into Eq. (92),

E_{T}=149.0273 MeV (93)

In a further embodiment, electrons from the electron beam 113 of FIG. 7 are warped into negative curvature by elastic scattering with photons from the photon source 105. The wavelength of each photon and the velocity of each electron is tuned such that the radius of each photon is equal to the radius of each electron. The relationship between the photon radius and wavelength is given by Eq. (35). The relationship between the electron radius and velocity is given by Eq. (61).

### EXPERIMENTAL II.

The electron-impact energy-loss spectrum of helium taken in the forward direction with 100 eV incident electrons with a resolution of 0.15 eV by Simpson, Mielczarek, and Cooper [Simpson, J. A., Mielczarek, S. R., Cooper, J., Journal of the Optical Society of America, Vol. 54, (1964), pp. 269-270] showed large energy-loss peaks at 57.7 eV, 60.0 eV, and 63.6 eV. Resonances in the photoionization continuum of helium at 60 eV and in the 63.6 eV region have been observed spectroscopically by Madden and Codling [Madden, R. B., Codling, K., Astrophysical Journal, Vol. 141, (1965), pp. 364-375] using synchrotron radiation. Absent was a resonance at 57.7 eV. Both Simpson and Madden assign the peaks of their data to two-electron excitation states in helium. Each of these states decay with the emission of an ionization electron of energy equal to the excitation energy minus the ionization energy of helium, 24.59 eV. The data of Goruganthu and Bonham [Goruganthu, R. R., Bonham, R. A., Physical Review A, Vol. 34, No. 1, (1986), pp. 103-125] shows ejected-energy peaks at 35.5 eV and at 39.1 eV corresponding to the energy loss peaks of Simpson of 60.0 eV and 63.6 eV, respectively. The absence of an ejected-energy peak corresponding to the energy-loss peak at 57.7 precludes the assignment of this peak to a two-electron resonance. The energy of each inelastically scattered electron of incident energy of 100 eV corresponding to the energy-loss of 57.7 eV is 42.3 eV. This is the resonance energy of pseudoelectron production by electron scattering from helium given by Eq. (66). Thus, the 57.7 eV energy-loss peak of Simpson arises from inelastic scattering of electrons of 42.3 eV from helium with resonant pseudoelectron production. The production of electrons with negative curvature is experimentally supported.

The electron-impact energy-loss spectrum of helium taken in the forward direction with 400 eV incident electrons by Priestley and Whiddington [Priestley, H., Whiddington, R., Proc. Leeds Phil. Soc., Vol. 3, (1935), p. 81] showed large energy-loss peaks at 42.4 eV, and 60.8 eV. A resonances in the photoionization continuum of helium at 60 eV has been observed spectroscopically by Madden and Codling [6] using synchrotron radiation. Absent was a resonance at 42.4 eV. Both Priestley and Madden assign the peaks of their data to two-electron excitation states in helium. Each of these states decay with the emission of an ionization electron of energy equal to the excitation energy minus the ionization energy of helium, 24.59 eV. The data of Goruganthu and Bonham [7] shows an ejected-energy peak at 35.5 eV corresponding to the energy loss peak of Priestley of 60.8 eV. The absence of an ejected-energy peak at 17.8 eV corresponding to the energy-loss peak at 42.4 precludes the assignment of this peak to a two-electron resonance. This is the resonance energy of pseudoelectron production by electron scattering from helium given by Eq. (30). Thus, the 42.4 eV energy-loss peak of Priestley arises from inelastic scattering of electrons of 42.3 eV from helium with resonant pseudoelectron production. The production of electrons with negative curvature is experimentally further supported.

What is claimed is:

1. A method of providing a repulsive force from a gravitating mass comprising the steps of:
providing an element of matter;
forming said element of matter into negative curvature wherein a repulsive force away from said gravitating mass is created;
applying energy from an energy source to said element of matter having negative curvature;
applying a field from a field source to said element of matter having negative curvature;
receiving the repulsive force on said field source from the said element of matter in response to the force provided by said gravitating mass and said element of matter.

2. The method of claim 1, wherein said step of providing an element of matter comprises the step of providing an electron.

3. The method of claim 2, wherein the step of forming comprises the step of
providing an electron beam and a neutral atom beam, and
providing the intersection of said beams such that the electrons form pseudospherical electrons.

4. The method of claim 3, wherein
the radius of each electron equals the radius of each neutral atom.

5. The method of claim 1, wherein the step of applying energy from an energy source to said element of matter having negative curvature comprises,
the acceleration of the negatively curved element of matter by an electric field.

6. The method of claim 1, wherein the step of receiving said repulsive force on said field source from said element of matter in response to the force provided by said gravitating mass and said element of matter comprises,
providing an electric field which produces a force on the said negatively curved element of matter which is in a direction opposite that of the force of the gravitating body on the element of matter.

7. The method of claim 6, further including the step of applying the received repulsive force to a structure movable in relation to said gravitating means.

8. The method of claim 7, further including the step of rotating said structure around an axis providing an angular momentum vector of said circularly rotating structure parallel to the central vector of the gravitational force by said gravitating mass.

9. The method of claim 8, further including the step of changing the orientation of said angular momentum vector to accelerate said structure through a trajectory parallel to the surface of said gravitating mass.

10. Apparatus for providing repulsion from a gravitating body comprising:
an element of matter;
means of forming said element of matter into negative curvature wherein a repulsive force away from said gravitating mass is created;
means of applying energy to said element of matter having negative curvature;
means of applying a field to said element of matter having negative curvature;
a repulsive force developed by said negatively curved element of matter in response to said applied field is impressed on said means for applying the field in a direction away from said gravitating body.

11. The method of claim 10, wherein said element of matter comprises an electron.

12. The method of claim 11, wherein the means of forming comprises
an electron beam and a neutral atom beam; wherein the beams intersect such that the electrons form pseudospherical electrons.

13. The method of claim 12, wherein
the radius of each electron equals the radius of each neutral atom.

14. The method of claim 10, wherein the means of applying energy from an energy source to said element of matter having negative curvature comprises,
a means to accelerate the negatively curved element of matter.

15. The means of claim 14 to accelerate the negatively curved element of matter comprising,
a means to provide an electric field.

16. The apparatus of claim 10, wherein the means to apply a field to provide a repulsive force against the negatively curved element of matter and receive the repulsive force on said element of matter by said gravitating mass comprises,
an electric field means which produces a force on the said negatively curved element of matter which is in a direction opposite that of the force of the gravitating body on the element of matter.

17. The apparatus of claim 10, further including
a circularly rotatable structure having a moment of inertia; and
means for applying said repulsive force to circulating rotatable structure, wherein
the angular momentum vector of said circularly rotatable structure is parallel to the central vector of the gravitational force produced by said gravitating body.

18. The apparatus of claim 17, further including
a means to change the orientation of said angular momentum vector to accelerate said said circularly rotatable structure along a trajectory parallel to the surface of said gravitating mass.

19. Apparatus for providing a repulsion from a gravitating body having:
an element of matter having negative curvature which experiences an antigravitational force in the presence of the gravitating body; and
means for applying a field to said negatively curved element of matter, wherein
a repulsive force is developed by said oppositely curved element of matter in response to said applied field and is impressed on said means for applying the field in a direction away from said gravitating body.
